(19) United States
(12) Patent Application Publication
(10) Pub. No.: US 2011/0226414 A1
(43) Pub. Date: Sep. 22, 2011

(54) COMPOSITION OF HOT-MELT, SELF-ADHESIVE PARTICLES AND STICKING METHOD USING SAME

(75) Inventor: Christian Guilhem, Albias (FR)

(73) Assignee: C-GEX SYSTEM, ALBIAS (FR)

(21) Appl. No.: 13/131,714

(22) PCT Filed: Nov. 26, 2009
(86) PCT No.: PCT/FR2009/052317

§ 371 Date: May 27, 2011

(30) Foreign Application Priority Data
Nov. 28, 2008 (FR) 0806699

(51) Int. Cl. B32B 37/12; C09J 131/04; C09J 123/12; C09J 123/06; C09J 175/04; C09J 177/00

(52) U.S. Cl. 156/273.1; 156/283; 524/563; 524/582; 524/585; 524/589; 524/606

(57) ABSTRACT

A composition of particles referred to as hot-melt, self-adhesive particles (10, 20), is made from a fusible thermoplastic material suitable for sticking parts together and having spikes (21) and/or barbs (11, 22) which can be hooked to the surface of at least one part to be stuck, in particular to the fibers of at least one surface of the parts to be stuck. A sticking method using such a composition is also described.

The invention relates to a gluing composition suitable for hot-gluing of parts, and more particularly for gluing a flexible, for example textile, covering on to a support, and to a gluing method using such a gluing composition.

Throughout the text, “powder” means any composition of solid particles in the divided state.

Document EP 0 350 979, for example, discloses methods for gluing a flexible covering on to a support, in which at least one of the covering and/or support surfaces to be glued is coated with a heat-activatable glue, and the parts to be glued are then brought to face each other and are pressed against one another while being heated. Under the influence of heat, the glue is activated, that is to say becomes adhesive and fixes to one another the two parts to be glued.

In such a method, it is conventional to employ a glue which has been sprayed beforehand on to a surface of one of the parts, as described, for example, in document FR 2 758 828. The known glues which are suitable for such a use are in general solvent-based glues or glues composed of particles of thermoplastic polymers dispersed in water.

These glues have several disadvantages. For example, the solvent-based glues generate toxic emissions during their use. Water-based glues contain at least 50% of their weight of water, that is to say water which plays no technical role at all in the gluing, but which introduces not inconsiderable increased costs during transportation and renders these glues susceptible to solidifying, which requires particular precautions during their transportation and their storage. In addition, once sprayed on to the parts to be glued, such glues must be subjected to a drying operation to render them manipulable before the subsequent operation of positioning the parts.

In addition, although hot-melt glues in the form of a dry powder are known, their use, as demonstrated by document FR 2 754 595, requires a first stage of applying glue to the support with a layer of glue of one of the above types to keep the powder on the support, and they can scarcely be used for productions of products in tape form.

There is therefore a need for a glue which does not have the abovementioned disadvantages of known glues.

The object of the invention is thus a gluing composition allowing its application in the dry state, without employing solvent or dispersing agent, to all surfaces, including fibrous surfaces to which glue has not been applied beforehand.

The object of the invention is also a gluing composition allowing gluing on the surface of parts facing each other, with a reduced penetration into the depth of the parts, and while preserving the flexibility of the glued parts.

The object of the invention is also such a gluing composition which allows adjustment of the strength of the gluing, as well as its spatial distribution over the surface to be glued.

The object of the invention is also a gluing composition which can be used with economical means.

The object of the invention is also a gluing method using such a composition, which allows selective gluing on surfaces of predetermined shape.

To this end, the invention provides a gluing composition comprising particles, called hot-melt self-gripping particles, formed in a material chosen from the group of hot-melt (that is to say fusible thermoplastic or also heat-reactivatable) glues and having characteristic spikes and/or barbs for attaching themselves in the surface of at least one part to be glued.

The particles of a composition according to the invention are particularly advantageously formed from a material which is solid at room temperature and is capable of acting as a hot-melt glue suitable for gluing flexible parts, in particular fabrics, nonwovens and foams, having a fibrous surface on at least one of their surfaces.

The particles of a gluing composition according to the invention moreover have characteristic spikes and/or barbs to penetrate and attach themselves in the fibers of a surface of such a flexible part. It is to be pointed out, however, that the particles of a gluing composition according to the invention can also attach themselves into a paste-like and/or adhesive layer present on the surface of one of the parts to be glued if this is not fibrous.

Thus, by spreading—in particular by projection—this gluing composition according to the invention on the fibrous surface of a part to be glued, the glue particles, in their solid state, attach themselves by their barbs to the fibers on which they have been deposited. The glue particles remain in place on the surface and are resistant to handling, which enables any drying operations as is the case with glues in liquid form to be eliminated. In addition, the glue particles employed in this way in the dry state form a plurality of glue points which are independent of each other and not, as with liquid or paste-like glues, a continuous surface. The elasticity of the parts to which glue has been applied in this way, in particular in the case of fine fabrics, is preserved and the boarded appearance obtained with the known glues can be avoided. Furthermore, the parts to be glued, which are either the support or the covering, can be stored without a precaution other than, where appropriate, the interposition of a non-fibrous insert to avoid attachment of parts to one another, since the glue is always in its initial state.

Advantageously and according to the invention, the particles are formed from pieces of filaments having a form factor between their length and the largest dimension of their cross-section of between 4 and 40. The average diameter of the pieces of filaments is between 0.05 mm and 1 mm, and preferably between 0.1 mm and 0.5 mm.

However, this very simple form of composition of hot-melt self-gripping particles shows a high capacity for penetration into the fibers and for anchoring themselves there at least for the time necessary to achieve the subsequent operation.

Advantageously and according to the invention, the pieces of filaments have barbs in the form of scales on their periphery. This characteristic allows the gripping power of the particles to be increased further and the proportion of particles which do not become attached at the time of deposition or which fall off during subsequent handling to be reduced.

According to one variant of the gluing composition according to the invention, the hot-melt self-gripping particles have the form of a flake, each comprising a plurality of barbed branches extending radially in projection from a central nucleus. This particularly advantageous form allows the attachment capabilities to be arranged in several directions. In particular, the barbed branches spread out in the same plane around the central nucleus. Alternatively, the barbed branches extend in all spatial directions. When deposited on the fibrous surface of one of the parts to be glued, the particles can thus still attach themselves to the facing surface of the other part, even though this is also fibrous, and can contribute towards keeping the two parts in position relative to one another before the actual gluing operations.

Advantageously and according to the invention, the central nucleus has a cross-section very much greater than that of the branches. Thus, during the actual gluing operation, that is to say when the supply of external heat causes the particles of hot-melt glue to melt, the finer branches melt first with less energy supplied than is necessary to cause the nucleus to melt. Pre-gluing can thus be achieved by melting of the branches before all the energy necessary for melting of the nuclei for a definitive gluing is supplied.

Advantageously and according to the invention, the central nucleus comprises a core formed from a material with a melting temperature higher than the melting temperature of the material forming the branches. In this version of the particle in flake form, not excluding the above, the difference between the melting temperature between the parts of the flake allows better control of the strength of the gluing, which can be regulated as a function of the amount of energy (heat) supplied during the hot-gluing operations.

Advantageously and according to the invention, the gluing composition is formed from a mixture of hot-melt self-gripping particles of different materials with different melting points. Thus, on the basis of a random distribution and independently of the material of the different hot-melt self-gripping particles, the proportion of hot-melt self-gripping particles which melt and produce a gluing point can be chosen by the temperature applied during the gluing operation and the spatial density of the gluing points can thus be regulated.

The invention also provides a method for gluing parts—in particular flexible parts—on to one another, according to which:
a hot-melt gluing composition is applied to at least one surface of at least one of the parts to be glued,
at least one surface thus treated of a part to be glued is applied to a corresponding surface of at least one other part to be glued,
the whole unit made up in this way is pressed and simultaneously heated to a predetermined temperature to activate the gluing composition,
   wherein as the gluing composition a composition of hot-melt self-gripping particles according to the invention is used.

Advantageously and according to the invention, at the stage of application an amount of hot-melt self-gripping particles of the said gluing composition is led in the dry state into a spraying device by means of a gas at a temperature below the minimum temperature at which the state of the gluing composition changes, and the hot-melt self-gripping particles are projected against the said surface of the part to be glued.

This method, which advantageously uses working means which are known per se and economical, such as a powder spraying device, is suitable for using a gas at a temperature sufficiently cold for the projected hot-melt self-gripping particles to remain in the solid state and to have a sufficient hardness for the spikes, barbs and roughnesses of the hot-melt self-gripping particles to attach themselves in the fibers of the surface against which they are projected.

Advantageously and according to the invention, the stage of application—in particular projection—of the gluing composition according to the invention is supplemented by a simultaneous stage of suction on the surface of the part to be glued opposite to the surface against which the hot-melt self-gripping particles are projected. Any “rebound” effect of the hot-melt self-gripping particles on the part to be glued is thus eliminated, while promoting the attachment of the hot-melt self-gripping particles, which are thus led into the fibers of the part.

Advantageously and according to the invention, the suction is carried out through a mask comprising at least one cut-out delimiting a zone on which the particles according to the invention are projected from a second zone free from hot-melt self-gripping particles according to the invention. By employing a stencil for the suction, the places where the hot-melt self-gripping particles attach themselves can be limited and precise selective gluings can be obtained.

Advantageously and according to the invention, the mask is placed between the projection device and the part to be glued, which allows the remainder of the surface of the part to be protected and, where appropriate, to be held in position. Alternatively, the mask is placed under the part, between this and the suction, which allows rapid changing of the part.

Advantageously and according to the invention, at the stage of application—in particular projection—of the gluing composition according to the invention an electrostatic charge of a first polarity is generated on a surface of the covering or of the support intended to receive the glue, and the hot-melt self-gripping particles of the gluing composition according to the invention are polarized with an electrostatic charge of opposite sign. It has thus been found that the hot-melt self-gripping particles have a tendency to align themselves such that their largest dimension is perpendicular to the plane of the charged surface, which facilitates their attachment.

Advantageously and according to the invention, a gluing composition comprising predetermined proportions of hot-melt self-gripping particles with staged melting temperatures is used, and at the stage of hot pressing the temperature and/or the duration of the operation is determined in order to modulate the strength of the gluing. By using a mixture of different types of hot-melt self-gripping particles, for example produced in materials with different melting points, these particles are distributed uniformly over the part to be glued during the projection. During the stage of pressing and heating the whole unit to be glued, the temperature reached determines the particles which melt and thus the percentage of glue points which form. In this way, for example, it is possible to achieve a pre-gluing where only a low percentage of the glue particles reach their melting point, or also a strong gluing in which a high percentage, indeed all of the particles have melted.

Advantageously and according to the invention, at the end of the stage of application—in particular projection—of the gluing composition, a hardening agent, which is capable of reaction with the hot-melt self-gripping particles during melting thereof, is applied thereto—in particular by spraying—in a manner such that the reversibility of the melting is limited. This hardening agent can itself also be in powder form, or can be in liquid form and can be sprayed just after the composition of hot-melt self-gripping particles or just before the stage of hot pressing.

In a variant or in combination, and always according to the invention, at the stage of application—in particular projection—of the gluing composition, a hardening agent, which is capable of reaction with the hot-melt self-gripping particles during melting thereof in a manner such that the reversibility of the melting is limited, is mixed with this. The hardening agent can also react only with a fraction of the hot-melt self-gripping particles, for example at the maximum gluing temperature, in order to allow a reversible pre-gluing and a virtually irreversible definitive gluing, thus allowing adjustments before the definitive gluing.

The invention also provides a composition of hot-melt self-gripping particles and a method of suing such a gluing composition, which comprises, in combination, all or some of the characteristics mentioned above or below.

Other aims, characteristics and advantages of the invention will emerge in view of the description which follows and the attached drawings, in which:

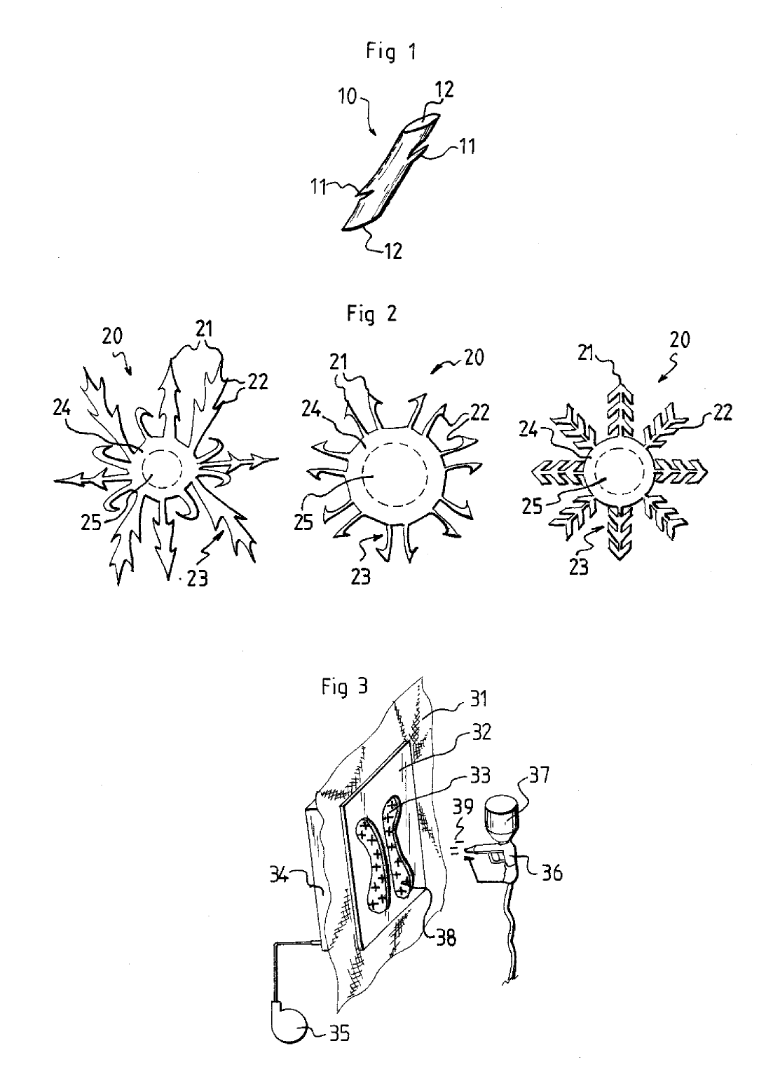

FIG. 1 shows a particle of a first type of the composition of hot-melt self-gripping particles according to the invention,

FIG. 2 shows three examples of a particle of a second type of the composition of hot-melt self-gripping particles according to the invention,

FIG. 3 shows a stage of the method of using the composition of hot-melt self-gripping particles according to the invention,

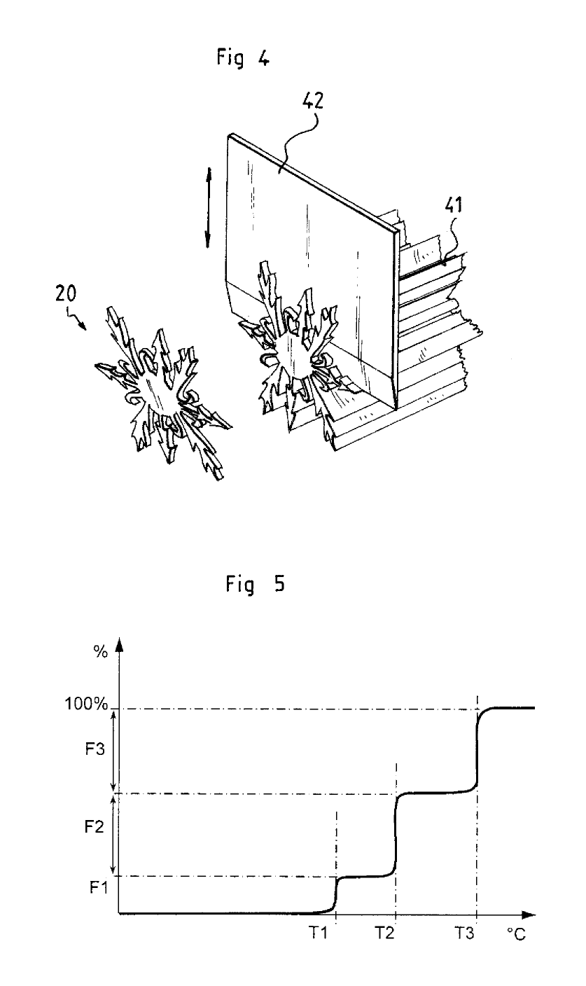

FIG. 4 shows a method of obtaining a particle of the second type of the composition of hot-melt self-gripping particles according to the invention, and

FIG. 5 is a graph which can be used for understanding an essential aspect of the method of using the composition of hot-melt self-gripping particles according to the invention,

The invention provides a composition of hot-melt self-gripping particles formed from solid particles such as platelets, filaments or flakes of one or more materials chosen from the group of materials which allow hot-melt glues capable of passing from a solid state at room temperature, for example, into a viscous or indeed liquid state when the temperature exceeds a predetermined temperature threshold as a function of the material used to be produced. The material chosen to form these particles is selected as a function of its ability to adhere to the material and the structure of the parts to be glued. Hot-melt glues in general contain polymers, such as polyethylenes, polypropylenes, polyamides, polyurethanes as well as copolymers, such as EVA (ethylene vinyl acetate), which form the base and are mixed with resins, waxes and other adjuvants which provide the actual characteristics, such as the adhesive power, in particular on fibrous surfaces, and modify other physical constants, such as the melting or glass transition temperatures. These produces are known per se and are conventionally supplied as extruded sticks, as granules or as films.

The essential characteristic of the composition of hot-melt self-gripping particles of the invention is that of being made of particles suitable for attaching themselves in the surface of one of the parts to be glued, and more particularly of being able to grip on the fibers of fibrous surfaces, such as fabrics, nonwovens, foams etc. Thanks to this property, the composition of hot-melt self-gripping particles according to the invention can be employed “in the dry state”, that is to say it requires neither a solvent nor a dispersing agent to be carried to and deposited on a part to be glued.

FIG. 1 shows a particle 10 of a composition of hot-melt self-gripping particles which is in the form of a piece of a filament of substantially cylindrical cross-section obtained, for example, by extrusion of one of the abovementioned materials in the form of a fine filament of a diameter of between 0.1 and 0.5 millimeters, from which lengths varying from 1 to 5 millimeters are cut out, preferably in a beveled manner to form spikes 12. It has been found that when the particles have this form factor varying between 4 and 40 between their diameter and their length, they have a tendency to lodge themselves in and between the fibers of fibrous surfaces, such as fabrics, nonwovens, foams, on which the particles are spread (“short hair” effect). Thus, in its simplest form the composition of hot-melt self-gripping particles of the invention is made up of such pieces of filaments which it is sufficient to spray on to a fibrous surface, such as, for example, a covering of fabric to be glued on a support.

The capacity of these particles for gripping on to fibers of the surface on which they have been sprayed by forming on their surface roughnesses and barbs, for example in the form of characteristic scales 11 for engaging the fibers of the surface can be improved further. The scales 11 are obtained, for example, during the extrusion of the filament by producing notches at regular intervals on the periphery of the filament and by drawing the filament notched in this way before cutting out pieces. Advantageously, these notches are made by knives moving in inclined planes back and forth in an orthogonal plane to the axis of the filament in a manner such that scales 11 opening in the two directions along the axis are obtained.

Another form of particle which can be used in a composition of hot-melt self-gripping particles of the invention is in the form of a flake 20, some examples of the profile of which are illustrated in FIG. 2. The flake 20 comprises a nucleus 24 from which a plurality of branches 23 extend radially. At the end opposite to the nucleus 24, the branches 23 carry at least one spike 21 with barbs 22. A flake of this form or of an analogous form can be produced as shown in FIG. 4 by extrusion of a profile 41 in the chosen hot-melt material and cutting out of this at the end of the extruder, when the cooled material is solid again, using a blade 42 oscillating in front of the die of the extruder. The dimensions of such a flake must be compatible with its use in the form of a powder for spraying on to a part to be glued, and, for example, the size of the branches ranges between 0.1 mm and 2 mm, for a thickness of 0.1 to 0.5 mm.

The flake 20 can also have a random shape, in that its contour has an irregular border comprising spikes, roughnesses and barbs allowing it to be anchored on a fibrous surface. Such a particle can thus be advantageously obtained by chopping a film of hot-melt material. The flakes 20 shown in FIG. 2 of course comprise branches 23 which extend in a plane, but the invention also applies to a flake of which the branches extend in the three spatial directions, such as, for example, a particle with a spherical nucleus comprising multiple branches in the form of hooks.

Such a flake has the benefit of being able to grip with some of its spikes on fibers of the fibrous surface of the part to be glued on to which it is projected, and to keep opposite to this spikes available for gripping it, where appropriate, on the surface of the support on to which this part is to be glued, if this also has a fibrous surface.

This characteristic form of the particle of a composition according to the invention thus allows, even before the start of the gluing process, a “weak” bonding to be achieved between the part to be glued and the support by attachment of some particles both to the support and to the part to be glued.

The nucleus 24 of the flake 20 in the examples illustrated in FIG. 2 is in the form of a cylinder of a thickness equal to that of the branches 23 and of a diameter substantially equal to or indeed even greater than the length of the branches. As a result, the cross-section and therefore the volume of the nucleus are substantially greater than those of the branches. This remarkable characteristic causes a different behavior of the branches and the nucleus during heating and melting of the particle at the time of gluing. For the same amount of energy supplied in the form of heat, the branches reach their melting temperature before the nucleus. By interrupting the supply of energy before the nucleus has melted, a gluing is thus obtained in which only the branches of the particles contribute. The glue point obtained at the level of each particle is therefore smaller in dimensions and the resulting gluing is less deep.

The nucleus 24 of the flake can also be made of a core 25 in the form of a cylindrical central part of a hot-melt material with a melting temperature higher than that of the material forming the periphery of the nucleus 24 and the branches 23. In a manner analogous to the preceding example, a glue point in which a variable part of the volume of glue constituting the particle is involved can thus be obtained.

It is therefore possible with the composition of hot-melt self-gripping particles of the invention to regulate the strength of the gluing at each glue point created by a particle of the composition.

However, it is also possible to regulate the strength of the gluing no longer at one point, but by a more or less dense distribution of the glue points over the entire surface of the gluing.

For this, the composition of hot-melt self-gripping particles is made up of a mixture of particles produced in different hot-melt materials, each having a different melting point and/or a different glass transition point. It is also possible to envisage, for example, a composition of hot-melt self-gripping particles made up to 20% of particles with a melting point of 60° C., 40% of particles with a melting point of 70° C. and 40% of particles with a melting point above 80° C. Other examples can be envisaged, for example with equal amounts of particles with a melting point of 100° C. and particles with a melting point of 120° C.

Once the particles have been mixed to form a relatively homogeneous composition of hot-melt self-gripping particles, the distribution of the different types of particles is perfectly random and, regardless of the mode of application to the surface to be glued, corresponds to an amount of particles of each type per unit of surface homogeneous with the proportions of the mixture.

In this manner, if an assembly of parts to be glued on to which a composition of hot-melt self-gripping particles corresponding to the above example is heated to above 60° C. but below 70° C., only the particles with a melting point of 60° C. will melt and form a glue point bonding the two parts. A gluing by points where only 20% of the potential glue points are formed is thus obtained. In addition, these points are uniformly distributed over the entire surface of the gluing. Similarly, if the assembly is heated to above 70° C., it will be 60% of the potential glue points which will be formed, and above 80° C. 100% of the particles will have formed a glue point, thus reaching the maximum effectiveness of the gluing. In this manner, the composition of hot-melt self-gripping particles of the invention allows a gluing of gradual intensity to be obtained.

One of the essential advantages of the composition of hot-melt self-gripping particles according to the invention rests in the fact that the glue particles employed in this way in the dry state form a plurality of separate glue points which are independent of each other and not, as with liquid or paste-like glues, a continuous surface. The elasticity of the parts glued in this way, in particular in the case of fine fabrics, such as jerseys, is preserved and the boarded appearance obtained with the known glues can be avoided. This property is also very advantageous during recycling at the end of the life of assemblies produced by means of such a composition of hot-melt self-gripping particles, in particular for seat furnishings or trims on the linings of the interior of automobiles. Recycling standards in fact require that the separation of the materials making up these assemblies, for example covering fabrics and foams forming the support, is as rigorous as possible. With the independent glue points formed by the composition of hot-melt self-gripping particles of the invention, during the peeling of the coverings only a minimum of points of the foam of the support are involved in the glue points (in contrast to gluings made with known liquid or paste-like glues which cause peeling of the entire surface of the foam sheets).

The composition of hot-melt self-gripping particles of the invention is used in a method for assembly by gluing a covering, in particular a flexible covering, on to a support, such as, for example, a foam seat furnishing. In such a method, which is known, for example, from EP 0 350 979, at least one of the covering and/or support surfaces to be glued is coated with a heat-activatable glue, and the parts to be glued are then brought to face each other and are pressed against one another while being heated. Under the influence of heat, the glue is activated, that is to say becomes adhesive and fixes to one another the two parts to be glued.

According to the invention, this method is adapted for use of a composition of hot-melt self-gripping particles according to the invention as described above, in particular during the first stage comprising deposition of the glue on to a surface of the covering or of the support. In this stage, the composition of hot-melt self-gripping particles is used in its dry state, that is to say, in contrast to the known former technique, without being dispersed in an aqueous binder. The dry composition of hot-melt self-gripping particles is used in a device for projection of powder, such as, for example, a gun 36 (FIG. 3) suitable for powder paint. It is to be noted, however, that such a gun must be suitable for the size of the particles to be projected. The composition of hot-melt self-gripping particles is poured into a feed reservoir 37, which may or may not be part of the gun 36. Inside this reservoir, the composition of hot-melt self-gripping particles is fluidized by a flow of gas, for example dry air, at a temperature below the minimum temperature at which the state of the composition of hot-melt self-gripping particles changes, that is to say distinctly below the lowest melting temperature of the materials employed for producing the particles. For example, if the melting temperature is 60° C., the gas employed should not exceed the temperature of 30° C., in order to preserve the rigidity and hardness of the particles. The composition of hot-melt self-gripping particles fluidized in this way is then projected by this flow of gas, or a parallel flow, in the direction of the covering surface 31 to be glued.

Advantageously, if the covering 31 is permeable to air, as is the case for a fabric, for example, it is placed on a chamber 34 connected to a suction source, such as a turbine 35. Once the covering 31 has been positioned on the chamber 34, it is kept in place by a mask 32 comprising cut-outs 33. In the example described, the mask 32 is placed on top of the covering 31, between this and the gun 36, which has the advantage that if the mask 32 is produced in a non-fibrous material, such as, for example, a polymethyl acrylate sheet, this allows the composition of hot-melt self-gripping particles to be recovered when projected outside the cut-outs 33. Alternatively, the mask 32 could be arranged between the covering 31 and the suction chamber 34, or also the covering 31 could be held between two homologous masks. The suction achieved in this way through the covering allows the particles of the composition to be anchored in the fibers of the covering in a more effective manner than by simple projection. In addition, the use of a mask 32 comprising cut-outs 33 produces a stencil which allows delimitation of masked zones which are free from the composition of hot-melt self-gripping particles and therefore will not be glued in the subsequent stages of the method with respect to zones situated under the cut-outs 33, on to which the composition of hot-melt self-gripping particles is projected and which will form glued zones. This arrangement allows gluings to be produced by specific zones which are useful in some applications (recessed gluings, three-dimensional shapes). It is also to be noted that the mask(s) themselves can also be produced in three dimensions if necessary.

To facilitate the adhesion of the composition of hot-melt self-gripping particles when it is projected on to a smooth surface, for example a metallic surface or a surface of wood or synthetic polymeric material, nothing prevents prior application to this surface of at least one layer of an adhesive primer (for example a layer of a self-gripping composition and/or of a material with a porous surface to retain the particles) allowing fixing of the particles.

Alternatively to the suction or in addition to this, the stage of projection of the composition of hot-melt self-gripping particles on to the covering can also advantageously be assisted by generation of differential electrostatic charges between the composition of hot-melt self-gripping particles and the covering. In fact, if the covering is impervious or slightly permeable to air, for example for fabrics covered with vinyl, suction is difficult to use. The same applies if the projection of the composition of hot-melt self-gripping particles is also carried out on to the support, in general made of elastic foam fixed on a wood or metal reinforcement, for which suction is certainly possible but sometimes not very practical.

It has thus been found that by generating an electrostatic charge 38 of a first polarity which is positive, as shown on FIG. 3, or negative, depending on the material of the surface of the covering or of the support intended to receive the composition of hot-melt self-gripping particles, and by polarizing the particles of the composition with an electrostatic charge 39 of opposite sign, it was possible to assist the projection of the composition and to improve the penetration of the spikes and barbs of the particles into the fibrous surface on to which these particles were projected. It has also been found that the electrostatic charge of the particles was concentrated at the ends (spikes) thereof, particularly if these particles are in the form of pieces of filaments, which has the effect of straightening these particles and placing them “in bristle form”, their long axis aligning with an orthogonal direction locally at the surface of the part to be glued. This thus provides a surface of the part to be glued, whether of the covering or of the support, on which the glue particles stand on end and present spikes opposite to the surface of the part, which can penetrate and anchor themselves in the surface of the other part, which allows precise positioning of one part on the other to be achieved.

It is also to be noted that a composition of hot-melt self-gripping particles according to the invention can also be deposited directly in contact with the walls of an injection mould for a part of foam or of synthetic polymeric material, in a manner such that at the time of removal from the mould it is then interlocked on the external surface of the part molded in this way.

Once at least one of the parts to be glued has been covered on one of its surfaces by the composition of hot-melt self-gripping particles of the invention, the method is continued by positioning the covering on the support, positioning which, as has been seen above, is facilitated by the capacity for attachment provided by the spikes and barbs of the particles of the composition which have been turned towards the facing surface of the other part to be glued.

In the following stage, the whole unit of support and covering is pressed against a bed of glass beads fluidized by hot air. As known per se, the bed of glass beads allows uniform veneering of the covering on the support, both in the recesses and on the protuberances thereof.

Advantageously, the temperature of the hot air serving to fluidize the bed of glass beads is chosen as a function of the characteristics of the composition of hot-melt self-gripping particles used and the required strength of the gluing. The same applies to the time during which this temperature is applied. Thus, if a composition of hot-melt self-gripping particles made up of particles comprising a solid nucleus surrounded by fine barbed branches is used, the application of a temperature slightly above the melting temperature of the material for a short time allows melting of the branches of the particles to take place without melting of the nucleus taking place. In practice, the amount of hot-melt material, therefore of glue, used is reduced and the gluing obtained in this way is weak and allows, for example, alteration of the positioning of the parts to be glued. On the other hand, if the temperature applied is significantly higher than the melting temperature of the material and it is applied for a time sufficient for melting of the branches and nucleus of the particles to take place, all the amount of glue available is used and the gluing reaches its maximum strength.

The same applies if a composition composed of particles of different materials with staged melting temperatures is used. As has been seen above, it is possible to make up a composition according to the invention comprising a mixture of different particles in predetermined proportions. For example, the case of a composition comprising a first proportion F1 of particles with a melting temperature T1, a second proportion F2 of particles with a melting temperature T2 higher than T1 and a third proportion F3 of particles with a melting temperature T3 higher than T2 has been shown on the graph of FIG. 5. If the whole unit of the parts to be glued is heated to a temperature higher than T1 but lower than T2, the use of such a composition allows melting only of the fraction F1 of the sprayed particles to take place, while preserving the shape of the particles of fractions F2 and F3. As a result, if it is necessary to separate the parts after this stage, only the particles of fraction F1 no longer fulfill their function of attaching the two parts together. The particles of the complementary fractions which have preserved their self-gripping characteristic allow repositioning of the parts to be glued.

By heating the whole unit to a temperature T2, fractions F1 and F2 of the sprayed particles melt, using a larger amount of glue and thus producing a stronger gluing. The same applies if the temperature T3 is exceeded, from where all the glue is used for a maximum gluing.

The use of a composition of hot-melt self-gripping particles, however, can be a disadvantage in certain cases of use where in the course of their service the parts glued by this method have to encounter temperatures higher than the melting temperature of at least one of the materials used. It is thus known to involve a hardening agent capable of reacting with the hot-melt materials during their melting to render this melting irreversible, or at least more difficultly reversible.

Advantageously, this hardening agent, if it is in liquid or pulverulent form, can be sprayed on to the composition of hot-melt self-gripping particles of the invention at the end of the projection of the particles on to the part to be glued. If the parts to be glued must be stored before the stage of hot pressing for a waiting time which may disturb the effect of the hardening agent, this can also be applied immediately before this stage.

Alternatively, if this hardening agent can be available in powder form, it can be mixed with the composition of hot-melt self-gripping particles prior to the projection thereof on to the parts to be glued and can be projected at the same time.

Regardless of its mode of application, the hardening agent can be appropriately chosen in a manner such that it reacts only from a predetermined temperature, for example in the case of a composition of hot-melt self-gripping particles comprising particles of several materials with staged melting temperatures, at the highest melting temperature. The hardening agent thus will not react with the fractions of the composition of which the melting temperature is lower, in order to allow a reversible pre-gluing and a virtually irreversible definitive gluing, thus allowing adjustments before the definitive gluing.

This description is of course given merely by way of illustrative example and the person skilled in the art will be able to apply numerous modifications to it without going beyond the scope of the invention, such as, for example:
modify the shapes of the particles and their attachment elements (spikes, barbs),
or also propose other methods (chemical rather than mechanical) for obtaining such particles,
or also other methods for application of the particles, for example:
   by the use of a dusting box with a perforated base fitted with a guillotine sheet which is itself perforated and mounted in a sliding manner on the base, and can be maneuvered alternately between a position for delivery of the composition of hot-melt self-gripping particles contained in the box, in which the perforations of the base and of the sheet are facing one another, and a position which closes the perforations of the base, the box possibly being connected to a compressed air source,
   or by the use of a laminating device comprising a first perforated hollow cylinder containing the particles which can be released through the perforations of this cylinder, and at least a second calender cylinder (preferably two calender cylinders) with a rough surface state, a sheet (covering of fabric, foam, leather . . . ) being passed between these cylinders in a manner such that the particles according to the invention are deposited on one surface of this sheet,
or also other methods for heating the particles, for example by infra-red irradiation and/or by laser and/or by conduction (contact with a heated part).

1. A gluing composition comprising particles, called hot-melt self-gripping particles, formed in a material chosen from the group of hot-melt glues, and having characteristic spikes (12, 21) and/or barbs (11, 12) for attaching themselves in the surface of at least one part to be glued.

2. The composition as claimed in claim 1, wherein the particles are formed from pieces of filaments (10) with a form factor between their length and the largest dimension of their cross-section of between 4 and 40.

3. The composition as claimed in claim 2, wherein the pieces of filaments have barbs in the form of scales (11) on their periphery.

4. The composition as claimed in claim 1, wherein the hot-melt self-gripping particles have the form of a flake (20), each comprising a plurality of barbed branches (23) extending radially in projection from a central nucleus (24).

5. The composition as claimed in claim 4, wherein the central nucleus (24) has a cross-section very much greater than that of the branches (23).

6. The composition as claimed in claim 4, wherein the central nucleus (24) comprises a core (25) formed from a material with a melting temperature higher than the melting temperature of the material forming the branches.

7. The composition as claimed in claim 1, which is formed from a mixture of hot-melt self-gripping particles of different materials with different melting points.

8. A method for gluing parts to one another, in which:
a hot-melt gluing composition is applied to at least one surface of at least one of the parts to be glued,
at least one surface thus treated of a part to be glued is applied to a corresponding surface of at least one other part to be glued,
the whole unit made up in this way is pressed and simultaneously heated to a predetermined temperature to activate the gluing composition,
wherein as the gluing composition a composition is used of hot-melt self-gripping particles as claimed in claim 1.

9. The method as claimed in claim 8, wherein at the stage of application an amount of hot-melt self-gripping particles of the said gluing composition is led in the dry state into a spraying device (36) by means of a gas at a temperature below the minimum temperature at which the state of the gluing composition changes, and the hot-melt self-gripping particles are projected against at least one surface of a part (31) to be glued.

10. The method as claimed in claim 9, wherein the stage of application of the gluing composition is supplemented by a simultaneous stage of suction on the surface of the part to be glued opposite to the surface against which the hot-melt self-gripping particles are projected.

11. The method as claimed in claim 10, wherein the suction is carried out through a mask (32) comprising at least one cut-out (33) delimiting a zone on which the hot-melt self-gripping particles are projected from a second zone free from hot-melt self-gripping particles.

12. The method as claimed in claim 11, wherein the mask (32) is placed between the projection device (36) and the part (31) to be glued.

13. The method as claimed in claim 8, wherein at the stage of application of the gluing composition an electrostatic charge (38) of a first polarity is generated on the surface of the part to be glued which is intended to receive the said composition, and the hot-melt self-gripping particles of the said gluing composition are polarized with an electrostatic charge (39) of opposite sign.

14. The method as claimed in claim 8, wherein a gluing composition comprising predetermined proportions (F1, F2, F3) of hot-melt self-gripping particles with staged melting temperatures (T1, T2, T3) is used, and at the stage of hot pressing the temperature and/or the duration of the operation is determined in order to modulate the strength of the gluing.

15. The method as claimed in claim 8, wherein at the end of the stage of application of the gluing composition, a hardening agent, which is capable of reaction with the hot-melt self-gripping particles during melting thereof, is applied thereto—in particular by spraying—in a manner such that the reversibility of the melting is limited.

16. The method as claimed in claim 8, wherein at the end of the stage of application of the gluing composition, a hardening agent, which is capable of reaction with the hot-melt self-gripping particles during melting thereof in a manner such that the reversibility of the melting is limited, is mixed with this.

17. The composition as claimed in claim 5, wherein the central nucleus (24) comprises a core (25) formed from a material with a melting temperature higher than the melting temperature of the material forming the branches.

18. The method as claimed in claim 8, wherein the stage of application of the gluing composition is supplemented by a simultaneous stage of suction on the surface of the part to be glued opposite to the surface against which the hot-melt self-gripping particles are projected.
